(19) United States
(12) Patent Application Publication
(10) Pub. No.: US 2024/0256435 A1
(43) Pub. Date: Aug. 1, 2024

(54) METHOD AND SYSTEM FOR TESTING COMPATIBILITY OF API SPECIFICATIONS

(71) Applicant: AGILE FAQS TECHNOLOGY PVT LTD., Mumbai (IN)

(72) Inventors: Naresh Bhawarlal JAIN, Mumbai (IN); Hari Krishnan P, Bengaluru (IN); Joel Cossy ROSARIO, Mumbai (IN)

(21) Appl. No.: 18/373,028

(22) Filed: Sep. 26, 2023

(30) Foreign Application Priority Data
Jan. 31, 2023 (IN) 202321006327

(51) Int. Cl. G06F 11/36; G06F 9/54; H04L 67/56

(52) U.S. Cl. CPC G06F 11/3692; G06F 9/541; G06F 11/3684; G06F 11/3688; H04L 67/56

(57) ABSTRACT

A system and method for testing compatibility between plurality of Application Programming Interface (API) specification standards is given. The method encompasses receiving at a communication unit [102] a first and second API specification associated with a single service. An adapter unit [104] then processes the said specifications to generate a first and second translated API specifications. Further, a first and second set of scenarios for said translated specifications are generated by a processing unit [106]. The method further comprises generating by a test engine [110] a set of executable tests based on the scenarios and initiating the said test(s). Thereafter, a proxy server [108] is initiated based on the second set of scenarios, and a target scenario is identified. The method includes generating response(s) for each target scenario and further, verifying by the test engine [110] said generated response(s) and generating a set of verification results. Thereafter, a compatibility report is generated by a compatibility report generator [112] based at least on the verification results.

### CROSS-REFERENCE TO RELATED APPLICATIONS

This application claims priority benefit from Indian Application No. 202321006327, filed on Jan. 31, 2023 in the India Patent Office, which is hereby incorporated by reference in its entirety.

### TECHNICAL FIELD

The present invention relates generally to the field of compatibility testing of an application programming interface (API) specification and more particularly to systems and methods for compatibility testing of one API specification with at least one other API specification for a single service.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Today, programmers write applications using a growing variety of publicly accessible Web services. Applications can access or request these publicly accessible services by invoking their corresponding Application Programming Interfaces (APIs). Such APIs have grown over the years, as businesses realize the growth potential associated with running an open platform that developers can interact with. An API Specification is a machine parseable document which describes an application programming interface between a provider and its consumers in an agreed format of communication. Such API specifications undergo improvements and are thus modified or evolved over time. A newer version of any API specification is recommended to be compatible with the older versions. The most important aspect of compatibility testing is to ensure that the software/applications developed based on an older version of the API specification continue to seamlessly work even when a newer version of the API specification is in place and is implemented. Specifically, backward compatibility is a technique to verify the behavior of the API Specification with their previous versions, failing which the consumer and provider will be unable to communicate with each other due to API Specification version mismatch. Providers may evolve the API features, for example, add new features which supports the new consumers but, in the process to attract more consumers, may break their contract with existing consumers. Further, forward compatibility is a reverse situation, wherein newer implementations of a specification can be read or emulated for the older version of the API specification. More particularly, a combination of the backward and forward compatibility which allows different versions of an application to interoperate without any issues, thereby the provider can generate data or modifications in the old or new format without having to lose its existing consumers.

Certain solutions exist that aid in testing backward compatibility between different versions of an API specification. The existing solutions identify discrepancies/issues with backward compatibility, late in the API testing cycle, usually after the deployment stage, which leads to unnecessary loggerheads.

Further, professionals other than engineers, are typically more accustomed to UI-based testing. API testing environments are typically complex since API testing handles massive chunks of responses to match fields and surface issues and thus, testing API responses typically requires writing code, parsing and testing different variables which may be difficult for non-developers to implement.

Some existing solutions rely on a text-based comparison approach wherein text of different version of the same API specification is compared to understand the difference between the versions. These solutions, however, are specific to an API Specification standard, possibly, even specific to the versions within the API Specification standard. These solutions are therefore unable to test backward compatibility between different API specification standards. Additionally, the existing solutions of testing backward compatibility are typically built for a particular programming language and platform, usually for a single domain. Because of this the system's vocabulary outside of its preferred domain may be limited.

Therefore, there are a number of limitations of the current existing solutions and there is a need in the art to provide an efficient tool for API specification compatibility testing.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present disclosure is to provide a solution for compatibility testing of an application programming interface (API) specification. Another object of the invention is to provide a system and method for testing compatibility between a first API specification and a second API specification, wherein compatibility testing includes backward compatibility testing, forwards compatibility testing and full compatibility testing.

In order to achieve the aforementioned objectives, one aspect of the invention relates to a method for testing compatibility between a first API specification and a second API specification. Said method comprises receiving, at a communication unit, the first API specification and the second API specification, wherein the first API specification and the second API specification are associated with a single service. Further, the method comprises processing, by an adapter unit, the first API specification through an interface to generate a first translated API specification. The method further encompasses processing, by the adapter unit, the second API specification through the interface to generate a second translated API specification. Further, the method comprises generating, by a processing unit, a first set of scenarios for the first API specification based on the first translated API specification and generating a second set of scenarios for the second API specification based on the second translated API specification. The method further encompasses generating, by a test engine a set of executable tests based on the first set of scenarios and initiating a proxy server based on the second set of scenarios. The method further comprises initiating, by the test engine, one or more executable tests from the set of executable tests, wherein each test from the set of executable tests is associated with a scenario from the first set of scenarios. The said method further comprises identifying, by the proxy server, a corresponding target scenario for each test from the one or more initiated tests, based on the second set of scenarios generating one or more responses for each said corresponding target scenario. Further, the method comprises verifying, by the test engine, the generated one or more responses for each said corresponding target scenario based on a scenario from the first set of scenarios, wherein said scenario is associated with the initiated one or more tests. Further, the method generates, via the test engine, a set of verification results based on verification of the generated one or more responses for each corresponding target scenario. Thereafter, the method comprises generating, by a compatibility report generator, a compatibility report based on at least the set of verification results.

Another aspect of the present disclosure relates to a system for testing compatibility between a first API specification and a second API specification Said system comprises a communication unit configured to receive the first API specification and the second API specification. Further, the system comprises an adapter layer connected to at least the communication unit, wherein the adapter layer is configured to process the first API specification through an interface to generate a first translated API specification. Further, the adapter layer is configured to process the second API specification through the interface to generate a second translated API specification. The system further encompasses a processing unit connected to at least the adapter layer, wherein the processing unit is configured to generate a first set of scenarios for the first API specification based on the first translated API specification and a second set of scenarios for the second API specification based on the second translated API specification. The system further comprises a test engine connected to at least the processing unit, wherein the test engine is configured to generate a set of executable tests based on the first set of scenarios and initiate one or more executable tests from the set of executable tests associated with a scenario from the first set of scenarios. The test engine thereafter verifies the generated one or more responses for each of the said corresponding target scenarios based on a scenario from the first set of scenarios, said scenario is associated with the initiated one or more tests, and generates a set of verification results based on the verification of the generated one or more responses for each of the said corresponding target scenarios. The system further comprises a proxy server connected to at least the test engine, wherein the proxy server is configured to generate a proxy implementation based on the second set of scenarios and identify a corresponding target scenario for each test from the one or more initiated tests based on the second set of scenarios. Thereafter, the proxy server generates one or more responses for each said corresponding target scenario. The system further comprises a compatibility report generator connected to at least the test engine and the proxy server; the said compatibility report generator is configured to generate a compatibility report based on at least the set of verification results.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system for testing compatibility between a plurality of API specifications, in accordance with exemplary embodiments of the present invention.

FIG. 2 illustrates an exemplary method flow diagram [200], for testing compatibility between a first API specification and a second API specification, in accordance with the exemplary embodiments of the present invention.

FIG. 3 illustrates an exemplary implementation of a system for testing API specifications for compatibility, in accordance with the exemplary embodiments of the present invention.

FIG. 4A illustrates an exemplary implementation of a method for testing API specifications for compatibility, in accordance with the exemplary embodiments of the present invention.

FIG. 4B illustrates an exemplary implementation of a method for testing API specifications for backward compatibility, in accordance with the exemplary embodiments of the present invention.

FIG. 4C illustrates an exemplary implementation indicating a method [400] for testing API specifications for forward compatibility, in accordance with the exemplary embodiments of the present invention.

FIG. 5A illustrates exemplary situations in which exemplary embodiments of the systems and methods of the present invention are implemented.

FIG. 5B illustrates another exemplary situation in which exemplary embodiments of the systems and methods of the present invention are implemented.

FIG. 6, illustrates an example compatibility test report generated in accordance with the exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a detection unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies and solutions for testing compatibility between API specifications have many limitations and in order to overcome at least some of the limitations of the prior known solutions, the present disclosure provides a solution for testing compatibility of an API specification including forward, backward and full compatibility for various versions of the same API specification or different API specifications, wherein backward and forward compatibility imply full compatibility. An API specification is a machine parseable document which describes an application programming interface between a provider and its consumers in an agreed format of communication. Providers may evolve the API features, for example, add new features which supports the new consumers, but in the process to attract more consumers, they may break their contract with existing consumers. The present invention provides a solution to predict and prevent identification of API specification version mismatch at any stage including specification authoring stage, pre-production stage, production stage, deployment stage, a specification review stage or while implementing in the CI/CD pipeline. The occurrence of at least one or more events such as version mismatch may be prevented by providing the necessary API compatibility testing and based on the implementation of the features of present invention.

The present invention provides a novel solution of testing compatibility between plurality of API specifications associated with a single service. Compatibility testing could encompass one of forward, backward or full compatibility between the old and new version of API specification at the provider and consumer side. The primary object is to ensure interoperability between the older and newer versions of the API specification.

To identify compatibility between two API specifications, say a first API specification and a second API specification, the present invention encompasses converting/translating the two API specifications under consideration into a common standardized format. A first set of scenarios are then generated based on the standardized/translated first API specification and a set of executable tests are then generated based on said first set of scenarios. These executable tests are then executed at a proxy server based on a second set of scenarios generated based on the second translated specification. A compatibility report is then generated based on the results of the set of executable tests run on the proxy server. The compatibility report provides the compatibility between the first and second API specifications and these are then stored for future reference. The details of the solution are described in further detail herein with reference to the drawings.

The present invention provides a technical advancement over the currently known solutions by providing the capability of cross-specification comparison of API specifications while migrating API specifications from one standard to another, etc. The present invention also provides a technical advancement over the currently known solutions by providing a pluggable architecture so that the solution can be used for testing compatibility between specifications of various API specification standards. Also, the present invention provides a technical advancement over the currently known solutions by providing a solution that is capable of holistically emulating the behavior of the provider on the consumer side as well as emulating the behavior of the consumer on the provider side, for implementing the different versions of the API specification. The present invention also provides a technical advancement over the currently known solutions by providing a comprehensive compatibility report by gathering the interaction data between the aforesaid simulated components, thereby, greatly reducing the complexity of existing solutions.

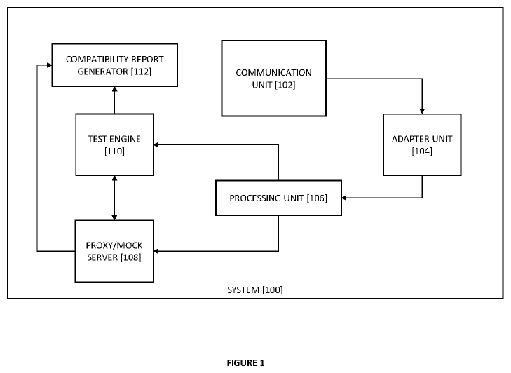

Hereinafter, exemplary embodiments of the present disclosure will be described in detail with reference to the accompanying drawings so that those skilled in the art can easily carry out the present disclosure. Referring to FIG. 1, an exemplary block diagram of a system [100] for testing an API specification for compatibility is shown. The system [100] comprises at least one communication unit [102], at least one adapter unit [104], at least one processing unit [106], at least one proxy server [108], at least one test engine [110], and at least one compatibility report generator [112]. Also, all of the units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure.

The system [100] is configured for testing compatibility between a plurality of API specifications, with the help of the interconnection between the units of the system [100].

More specifically, in order to implement the features of the present disclosure, the communication unit [102] is configured to receive a first API specification and a second API specification, being associated with a single service. In one implementation the first API specification and the second API specification could be different versions of the same API specification, but the disclosure is not limited thereto and the first and second API specifications could be different API specifications for a service. For example, the first API specification may be an older version of the API specification and the second API specification is a newer version of the same API specification.

Further, the communication unit [102] then provides such received API specifications to an adapter unit [104]. The adapter unit [104] is configured to parse the first API specification and the second API specification file and build an internal unified standard model of each of the first and second API specifications. The adaptor unit [104] has a pluggable architecture.

The processing unit [106] may be a unit that is connected to the adapter unit [104], wherein each translated API specification is received. The processing unit [106] is configured to process the first translated specification and the second translated API specification to generate one or more possible scenarios. Each generated scenario, includes at least a pre-condition, at least a cause and at least an effect, wherein the pre-condition is a possible trigger for an action, a cause is a possible action and an effect is in the form of a response. In one implementation processing unit [106] is connected to at least a test engine [110] and the proxy server [108]. The test engine [110] is configured to receive the first set of scenarios for the translated version of the first API specification and the proxy server [108] is configured to receive the second set of scenarios for the translated version of the second API specification.

Further, the test engine [110] is configured to generate a set of executable test cases for each scenario in the first set of scenarios generated by the processing unit [106], wherein the set of executable test cases is a set of actions performed on a system to check if the system meets the requirements. The set of executable test cases are verified for boundary conditions and combination of inputs. The boundary testing constraints the test case run in terms of setting a range or limit. In an implementation, each executable test orchestrates the following activities such as checking for setup pre-conditions, initiating request with appropriate protocol as per the specification standard and verify the test case, wherein the specification standard could be in OpenAPI, AsyncAPI, Swagger, API Blueprint, RAML, or an internal format in Domain Specific Language (DSL), but the disclosure is not limited thereto.

Further, the proxy server [108] is connected to at least the processing unit [106] and is configured to receive the second set of scenarios and the testing request initiated by the test engine [110]. The proxy server [108] is an instance of parallel application development in request-response systems. Furthermore, the proxy server [108] identifies a target scenario (from the second set of scenarios) for each initiated test. The proxy server [108] then generates a response for each of the identified target scenarios. The proxy server [110] maintains a record of all set of scenarios, incoming requests, successful matches and responses generated.

Furthermore, a compatibility report generator [112] connected to at least test engine [110] and at least proxy server [108], collates a list of compatible changes, a list of in-compatible changes, a list of structural changes, a list of unverified scenarios and time computation for executing each scenario. The compatible changes is a conclusion to the fact that the older and newer version of the API specification have passed the compatibility testing and vice-versa is true for in-compatible changes. Furthermore, the unverified scenarios are those scenarios that have not been tested by the test engine [110] and the proxy server [108]. For example an OpenAPI 3.x standard may support a link which is able to convey which API endpoint and operation needs to be called before another one, describing workflow, however, this capability may not be available in another standard like APIBluePrint or Swagger 2 and hence, the system [100] cannot verify if there has been a change in the workflow itself. Such a scenario is listed under the unverified scenarios.

A person skilled in the art would appreciate that the above list of features is only exemplary and does not restrict the disclosure in any possible manner.

Furthermore, the system [100] is capable of testing compatibility between API specifications. In the present solution, compatibility testing could encompass forward or backward compatibility, and by way of implication full compatibility, with the old and new version of API testing at the provider and consumer side. The primary object is to ensure interoperability between the older and newer versions of the same API specification. Backward compatibility means having legacy implementation ability, thus while making changes on the request-response schema the existing clients are able to send requests and decode those responses. Henceforth, an API specification is said to be backward compatible with its newer or latest version, thus every specification under the older version is still valid. In an implementation, the old version of the API specification is executed by the test engine [110] to generate executable test cases for each set of scenario and the new version of the same API specification or a different API specification is implemented on the proxy server [108]. Further, forward compatibility is a reverse situation where in an implementation, the new version of the API specification is executed on the test engine [110] and the old version is implemented on the proxy server [110]. Thereby, newer implementations of a specification can be read or emulated for the older version of the API specification. A combination of the backward and forward compatibility allows different versions to interoperate without any issues, thereby the provider can generate data or modifications in the old or new format without having to lose its existing consumers.

In an implementation of the present disclosure, the present invention encompasses a computer readable medium comprising instructions, which when executed cause a processor to perform a method for testing compatibility between a first API specification and a second API specification. Said method comprises receiving the first API specification and the second API specification, wherein the first API specification and the second API specification are associated with a single service. Further, the method comprises processing the first API specification through an interface to generate a first translated API specification. The method further encompasses processing the second API specification through the interface to generate a second translated API specification. Further, the method comprises generating a first set of scenarios for the first API specification based on the first translated API specification and generating a second set of scenarios for the second API specification based on the second translated API specification. The method further encompasses generating a set of executable tests based on the first set of scenarios and initiating a proxy server based on the second set of scenarios. The method further comprises initiating one or more executable tests from the set of executable tests, wherein each test from the set of executable tests is associated with a scenario from the first set of scenarios. The said method further comprises identifying a corresponding target scenario for each test from the one or more initiated tests, based on the second set of scenarios generating one or more responses for each said corresponding target scenario. Further, the method comprises verifying the generated one or more responses for each said corresponding target scenario based on a scenario from the first set of scenarios, wherein said scenario is associated with the initiated one or more tests. Further, the method generates a set of verification results based on verification of the generated one or more responses for each corresponding target scenario. Thereafter, the method comprises generating a compatibility report based on at least the set of verification results.

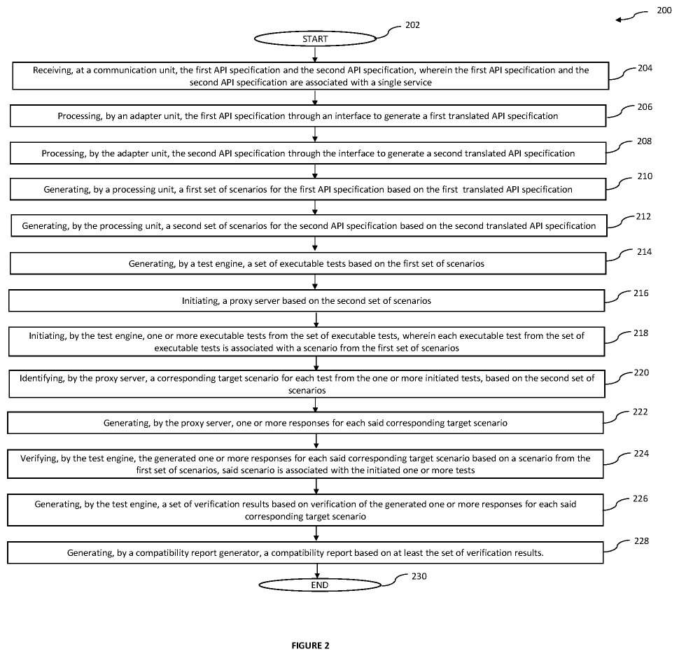

Referring to FIG. 2 exemplary method flow diagram [200], for providing testing of API specification, in accordance with exemplary embodiments of the present invention is shown. In an implementation the method is performed by the system [100]. Further, in an implementation, the system [100] may be present in a consumer device to implement the features of the present invention. Also, as shown in FIG. 2, the method starts at step [202] and proceeds to step 204. The method may begin when a user interacts with the communication unit [102] to start compatibility check between two API specifications. In another example, the method may begin when a user interacts with the communication unit [102] to update an existing API specification at the consumer device. The method may begin when a user interacts with the communication unit [102] to persist an existing API specification in a repository where API specifications are stored. The method may also begin when different versions of an application are tested during production or pre-production stage.

At step 204, the first API specification and the second API specification are received at the communication unit [102]. The first and second API specification are associated with a single service. In one implementation the first and second API specification are different versions of the same API specification, but the disclosure is not limited thereto and the first and second API specification could be different API specifications for a single service. Further, the plurality of API specification can be in at least one of widely accepted standards OpenAPI, AsyncAPI, Swagger, API Blueprint, RAML, or an internal format in Domain Specific Language (DSL), but the disclosure is not limited thereto. The first API specification and the second API specification may be received at the communication unit [102] as a result of a user uploading or adding such specifications using a user interface, wherein the first and second API specifications may be pulled from a central repository or local storage.

For ease of understanding, let us take an API specification version 1 and an API specification version 2, wherein the API specification version 1 and the API specification version 2 are the versions of the same API specification.

At step 206 and step 208, the first and second API specifications are processed by an adaptor unit [104]. The adapter unit [104] parses the first and the second API specification files and constructs an internal unified standard model of the API specifications. Further, the internal model ensures that irrespective of source of the API specification, there is a common and consistent description of the API behavior. Thereby, the adapter unit [104] generates a first and second translated API specification in a standardized internal format.

Step 210 and 212, comprises generating, by the processing unit [106], a first set of scenarios for the first translated API specification and a second set of scenarios for the second translated API specification. Further, the processing unit [106] converts the API specification into a base proprietary model of scenarios, thereby, supporting additional standards. Further, the first translated API specification and the second translated API specification are processed to generate a set of all possible scenarios, wherein each scenario includes at least a precondition, at least a cause and at least an effect.

Continuing with the above example, a first set of scenarios say, X, Y and Z are generated from the first translated API specification and a second set of scenarios say A, B and C are generated by the second translated API specification. As shown in the below example, the first and second set of scenarios each comprises at least a pre-condition, at least a cause and at least an effect.

| First set of scenarios | Pre-condition | Cause | Effect/Response |
|---|---|---|---|
| X | P1 | C1 | E1 |
| Y | P2 | C2 | E2 |
| Z | P3 | C3 | E3 |

| Second set of scenarios | Pre-condition | Cause | Effect/Response |
|---|---|---|---|
| A | P4 | C4 | E4 |
| B | P5 | C5 | E5 |
| C | P6 | C6 | E6 |

Step 214 comprises generating, by the test engine [110], a set of executable tests based on the first set of scenarios generated by the processing unit [106]. Each one or more executable tests from the set of executable tests is associated with a scenario from the first set of scenarios. In the above example, for scenario X tests T1 and T2 are generated, for scenario Y tests T3 and T4 are generated and for scenario Z test T5 is generated.

At step 216, the proxy server [108] is initiated based on the second set of scenarios generated by the processing unit [106], as explained in the above example. Thereafter, step 218 comprises initiating, by the test engine [110], one or more executable tests from the set of executable tests, wherein each executable test from the set of executable tests is associated with a scenario from the first set of scenarios.

At step 220, the proxy server [110] identifies a corresponding target scenario from the second set of scenarios, for each test from the one or more initiated tests at step 218, wherein the target scenario is based on the second set of scenario matched from the set of executable tests executed by the test engine [110].

In the above example, let us say, test T1 is initiated by a test engine [110] and sent to a proxy server [108]. Now, a request matcher in the proxy server [108] will see which scenario matches with Test T1. Say from the second set of scenarios, scenario B matches with test T1. Thus, the target scenario identified by the proxy server in this example is the scenario B.

At step 222, the proxy server [108] generates one or more responses (a success or a failure), for each corresponding target scenario identified at step 220.

At step 224, the test engine [110] verifies the generated one or more responses at step 222 for each corresponding target scenario based on a scenario from the first set of scenarios, where the said scenario is associated with the initiated set of tests. Further, the verification of response is a record of a subset or super set of expected details, for instance, an OpenAPI may leverage a JSON verifier, WSDL may leverage an XML verifier but the present disclosure is not limited thereto.

Continuing with the above example, a response generator (at the proxy server) generates all set of responses for scenario B i.e. E5. Furthermore, the response E5 is passed back to the test engine [110]. Now, response verifier knows T1 was for scenario X from the first set of scenarios and additionally, it also knows the response for scenario X i.e., E1. The response verifier compares E1 and E5 and generates a success or a failure output for test T1 and stores the result in a test registry.

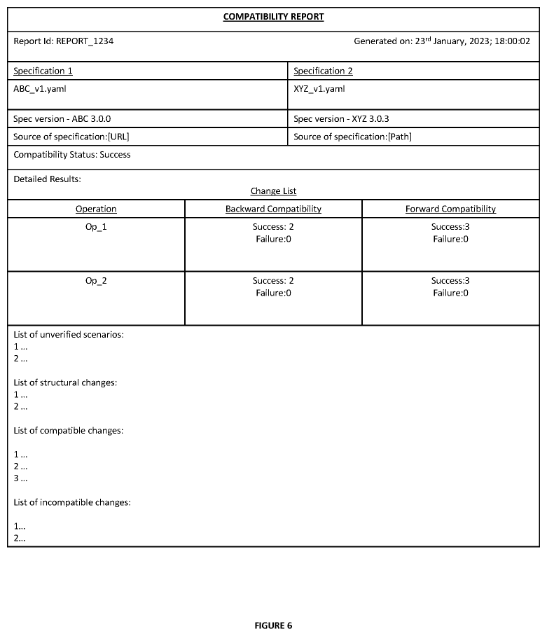

At step 228 and as depicted in FIG. 6, a compatibility report generator [112] generates a compatibility report comprising a list of compatible changes, a list of incompatible changes, a list of structural changes, a list of unverified scenarios and time computation but the present disclosure is not limited thereto.

Further, taking another example to illustrate forward compatibility testing, here the consumer or client must go live before the provider. In this example, an optional parameter can be added to the response schema, i.e., the consumer, while implementing a change, is aware of the possibility that the parameter is not available. Thereby, it is possible to work with the existing version of the provider or service that does not send this optional parameter. Furthermore, the optional parameter can be removed from the request schema, i.e., the consumer implementing this change will not send the optional parameter that was removed. However, the existing provider, which was already handling the possibility of not receiving this parameter, can still support the client, which has already moved to the next version of the specification.

After providing the testing of plurality API specification for compatibility, the method terminates at step [230].

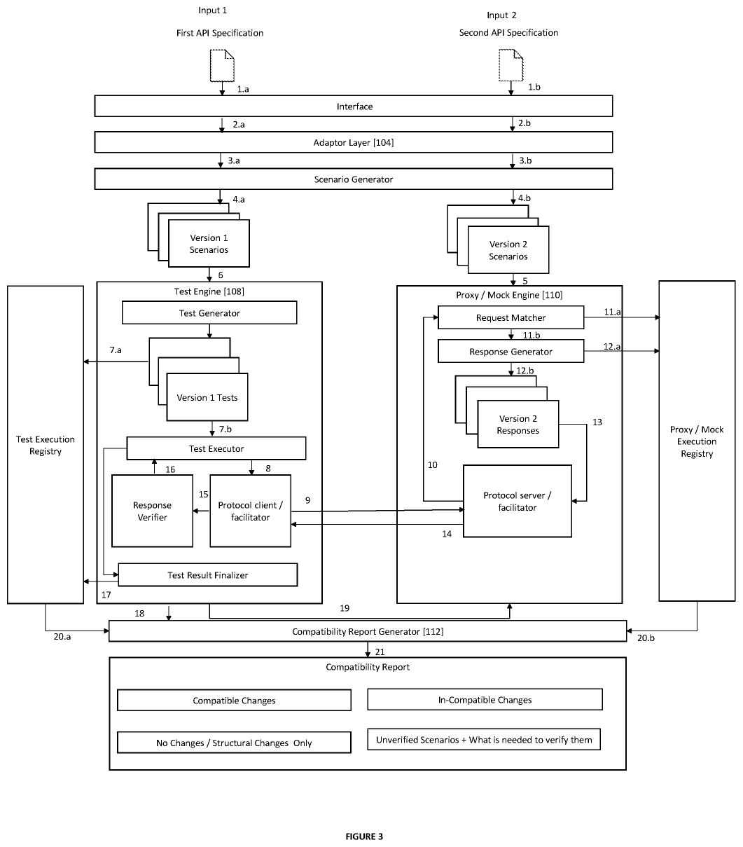

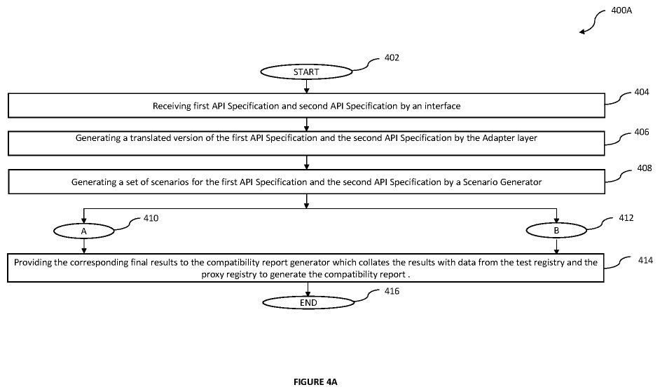

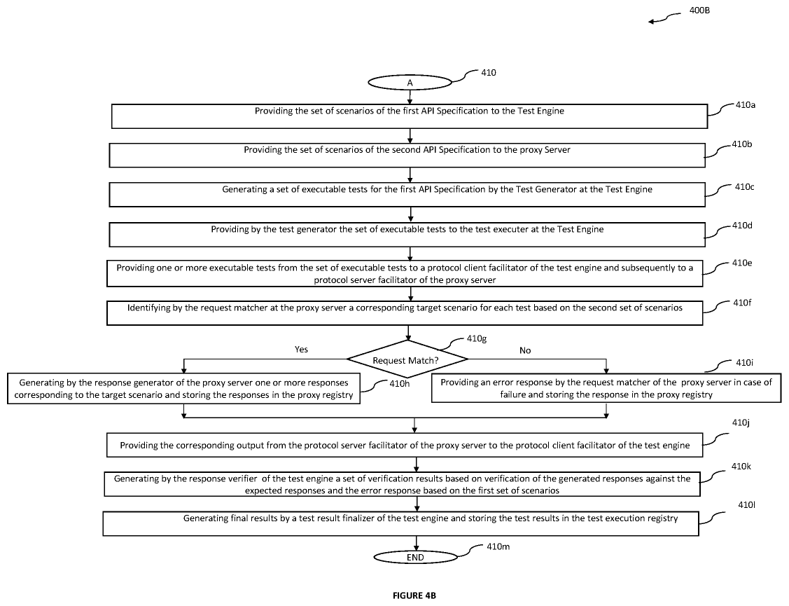

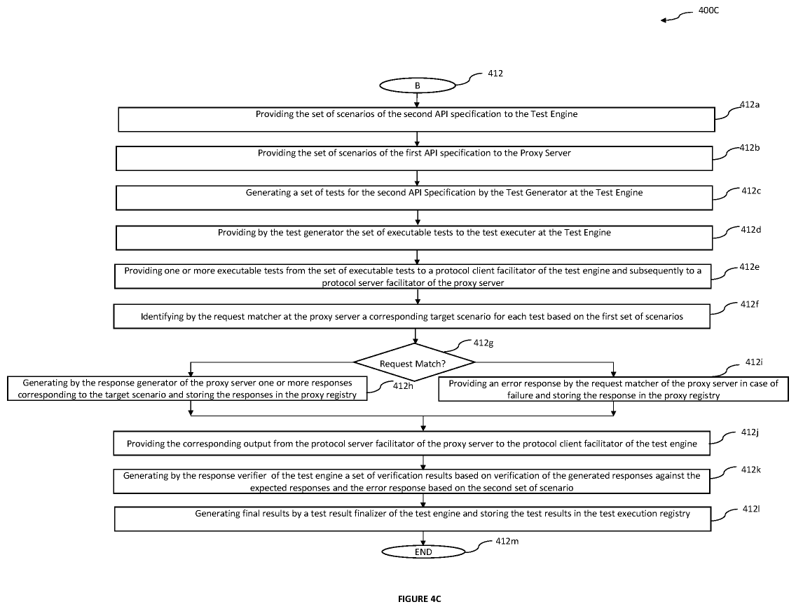

To illustrate, FIGS. 3 and 4 depicts exemplary scenarios indicating testing of API specification for compatibility, in accordance with the exemplary embodiments of the present invention. At step 404, an interface as depicted in FIG. 3, is configured to receive a plurality of API specifications, where the API specification could be different versions of the same API specification or different API specifications. The API specification is in a widely accepted specification standard such as OpenAPI, AsyncAPI, Swagger, API Blueprint, RAML or an internal format in Domain Specific Language (DSL) but the present disclosure is not limited thereto. The interface could be one of command line interface, web interface but the present disclosure is not limited thereto. In an exemplary implementation, the command line interface allows the user to interact with the system or to provide input to the system [100].

Further in the above exemplary implementation, an adapter unit [104] comprises an adapter layer, as depicted in FIG. 3, which at step 406 is configured to parse the plurality of API specification files and construct an internal unified standard model of the API specifications into a first translated API specification and a second API specification. Furthermore, the internal model ensures that irrespective of the source of the specification, there is a common and consistent description of API behavior. At step 408, the scenario generator (as depicted in FIG. 3), generates a possible set of scenarios as explained in the above example, for the plurality of API specifications. Further, the scenario generator processes the internal model/translated versions of the plurality of API specifications to generate all possible scenarios including at least a pre-condition, at least a cause and at least an effect but the disclosure is not limited thereto. For instance, a scenario generated by the scenario generator may be in the following form:
Given there is a product with id 1 in the system
When Http GET request is made to/products/1
Then the response should include product 1 details
Given there is a channel named “messages”
When Http POST request is made to/messages URL with a “hello”
Then we get back a response with status 201
And the “hello” appears in the channel named “messages”

Further, the method from step 410 (in FIG. 4a) in the above exemplary implementation of the present invention represents backward compatibility testing for API specifications. The step 412 (in FIG. 4b) in the above exemplary implementation of the present invention represents forward compatibility testing for API specifications.

FIG. 4a in the above exemplary implementation of the present invention represents backward compatibility testing. A test engine [110] as depicted in FIG. 3, is initiated at step 410a and the test engine [110] is configured to receive a first set of scenarios for the first translated API specification generated by the scenario generator. Furthermore, a proxy server [108] at step 410b is configured to receive a second set of scenarios for the second translated API specification generated by the scenario generator.

Furthermore, the test engine [110] comprises a test generator as depicted in FIG. 3, which generates or breaks down the first set of scenarios into constituent set of executable test cases at step 410c. For instance,
Scenario: product ids in range 1 to 3
When GET/products/{number:1..3}
Then status 200
Can be broken down into:
GET/products/0
Then status not 200
GET/products/4
Then status not 200
GET/products/1
Then status 200

In an exemplary embodiment of the present invention, the test generator verifies boundary conditions and possible combination of inputs. Each executable test generated is associated to a particular scenario from the set of scenarios generated at step 408.

Further, a test registry as depicted in FIG. 3 and at step 414, maintains an account of executable tests generated, tests run, the corresponding results in the form of success, failure or error, time taken for each activity, but the disclosure is not limited thereto. This maintenance of tests is later used to generate a compatibility report at step 414 and as depicted in FIG. 6. At step 410d, the set of executable tests for the first API specification are processed by a test executor, the test executor orchestrates the following activities:
a) setup preconditions—for instance, includes sending a message to a queue, sending a priming request, etc.
b) execute action—for instance, initiating request with appropriate protocol as per the specification
c) verify or assert—for instance, taking the response from a protocol client and sending it to response verifier which is based on the specification, like JSON matcher, XML matcher, etc.

Further, a protocol client/facilitator of the test engine [110] is a pluggable or dynamically bound unit which is selected at step 410e based on the protocol of the specification. For instance, OpenAPI may use a http or rest client, AsycnAPI with JMS protocol may use a JMS client. Further, a protocol server/facilitator in the proxy server [108] is similarly, a pluggable or dynamically bound unit which is selected based on the protocol of the specification For instance, OpenAPI will leverage a server like ktor, AsyncAPI, JMS protocol will leverage a suitable JMS server etc. The one or more executable tests from the set of executable tests generated are provided by the test generator to the protocol client facilitator of the test engine [110] and subsequently, to the protocol server facilitator of the proxy server [108].

Furthermore, a request matcher of the proxy server [108] as depicted in FIG. 3, is configured to receive request from the protocol server/facilitator at step 410f. The request matcher matches the request received from the protocol server/facilitator with available scenarios at step 410g. The following illustrates the functioning of the request matcher, where the first scenario from the first API specification will be matched to the fourth scenario from the second API specification:

| | First API specification | | | | Second API specification | | |
|---|---|---|---|---|---|---|---|
| | First set of scenarios | | | | Second set of scenarios | | |
| S. No. | Method | Path | Data | S. No. | Method | Path | Data |
| 1 | POST | /products | {schema} | 1 | GET | /order | |
| | | | | 2 | GET | /products | |
| | | | | 3 | POST | /products | {partial |
| | | | | | | | schema} |
| | | | | 4 | POST | /products | {schema} |

However, if the request matcher fails to find a match between the first set of scenarios from the test engine [110] and the second set of scenarios from the proxy server [108], then an error response is recorded at step 410i and stored in the proxy registry. The proxy execution registry is configured to maintain a record of set of all possible scenarios, possible set of requests, successful matches, failed matches, possible set of responses etc.

Furthermore, at step 410h, a response generator of the proxy server [108] receives the corresponding target scenario from the request matcher as depicted in FIG. 3, in case of a successful match the target scenario, and stores the responses in a proxy registry. Furthermore, the response generator of the proxy server [108] generates all possible responses as success or failures.

Furthermore, at step 410j, the corresponding output from the protocol server/facilitator of the proxy server [108] is fed to the protocol client/facilitator of the test engine [110]. A response verifier of the test engine [110] is configured to receive the responses from the protocol client/facilitator, as depicted in FIG. 3. Step 410k includes generating by the response verifier a set of verification results based on verification of the generated responses. Further, the response verifier is a pluggable/dynamically bound unit which is selected based on the serialization and protocol in the specification. For instance, an OpenAPI may leverage a json verifier, WSDL may leverage an XML verifier. Thereby, the response verifier records the response that is a subset or super set of expected details. To elaborate, the response received from the proxy server [108] is based on second API specification and if that specification has removed or added i.e., modified some of the possible responses, the response verifier, which is based on the first API specification, will check if there is a delta/change between the expected and actual response at the two levels. Henceforth, within each response received there is a schema level check, and overall total number of possible responses returned by the proxy server [108] and the total number of expected responses is also verified.

In FIG. 4b in the above exemplary implementation of the present invention represents forward compatibility testing. A test engine [110] as depicted in FIG. 3, is initiated at step 412a and the test engine [110] is configured to receive a second set of scenarios for the second translated API specification generated by the scenario generator. Furthermore, a proxy server [108] at step 412b is configured to receive a first set of scenarios for the first translated API specification generated by the scenario generator.

Furthermore, the test engine [110] comprises a test generator as depicted in FIG. 3, which generates or breaks down the second set of scenarios into constituent set of executable test cases at step 412c. For instance,
Scenario: product ids in range 1 to 3
When GET/products/{number:1..3}
Then status 200
Can be broken down into:
GET/products/0
Then status not 200
GET/products/4
Then status not 200
GET/products/1
Then status 200

In an exemplary embodiment of the present invention, the test generator verifies boundary conditions and possible combination of inputs. Each executable test generated is associated to a particular scenario from the set of scenarios generated at step 408.

Further, a test registry as depicted in FIG. 3 and at step 4121, maintains an account of executable tests generated, tests run, the corresponding results in the form of success, failure or error, time taken for each activity but the disclosure is not limited thereto. This maintenance of tests is later used to generate a compatibility report at step 414 and as depicted in FIG. 6. At step 412d, the set of executable tests for the second API specification are processed by a test executor, the test executor orchestrates the following activities:
a) setup preconditions—for instance, includes sending a message to a queue, sending a priming request, etc.
b) execute action—for instance, initiating request with appropriate protocol as per the specification
c) verify or assert—for instance, taking the response from a protocol client and sending it to response verifier which is based on the specification, like JSON matcher, XML matcher, etc.

Further, a protocol client/facilitator of the test engine [110] is a pluggable or dynamically bound unit which is selected at step 412e based on the protocol of the specification. For instance, OpenAPI may use a http or rest client, AsycnAPI with JMS protocol may use a JMS client. Further, a protocol server/facilitator in the proxy server [108] is similarly, a pluggable or dynamically bound unit which is selected based on the protocol of the specification. For instance, OpenAPI may use a server like Ktor, AsycnAPI, JMS protocol may use a JMS queue etc. Thereby, providing one or more executable tests from the set of executable tests generated by the test generator to the protocol client facilitator of the test engine [110] and subsequently, to the protocol server facilitator of the proxy server [108].

Furthermore, a request matcher of the proxy server [108] as depicted in FIG. 3, is configured to receive request from the protocol server/facilitator at step 412f. The request matcher matches the request received from the protocol server/facilitator with available scenarios at step 412g. The following illustrates the functioning of the request matcher, where the first scenario from the second API specification will be matched to the fourth scenario from the first API specification:

| | Second API specification | | | | First API specification | | |
|---|---|---|---|---|---|---|---|
| | Second set of scenarios | | | | First set of scenarios | | |
| S. No. | Method | Path | Data | S. No. | Method | Path | Data |
| 1 | POST | /products | {schema} | 1 | GET | /order | |
| | | | | 2 | GET | /products | |
| | | | | 3 | POST | /products | {partial |
| | | | | | | | schema} |
| | | | | 4 | POST | /products | {schema} |

However, if the request matcher fails to find a match between the second set of scenarios from the test engine [110] and the first set of scenarios from the proxy server [108], then an error response is recorded at step 412i and stored in the proxy registry. The proxy execution registry is configured to maintain a record of set of all possible scenarios, possible set of requests, successful matches, failed matches, possible set of responses etc.

Furthermore, at step 412h, a response generator of the proxy server [108] receives the corresponding target scenario from the request matcher as depicted in FIG. 3, in case of a successful match the target scenario, and stores the responses in a proxy registry. Furthermore, the response generator of the proxy server [108] generates all possible responses as success or failures.

Furthermore, at step 412j, the corresponding output from the protocol server/facilitator of the proxy server [108] is fed to the protocol client/facilitator of the test engine [110]. A response verifier of the test engine [110] is configured to receive the responses from the protocol client/facilitator, as depicted in FIG. 3. At step 412k includes generating by the response verifier a set of verification results based on verification of the generated responses. Further, the response verifier is a pluggable/dynamically bound unit which is selected based on the serialization and protocol in the specification. For instance, an OpenAPI may leverage a json verifier, WSDL may leverage an XML verifier. Thereby, the response verifier records the response that is a subset or super set of expected details. To elaborate, the response received from the proxy server [108] is based on first API specification and if that specification has removed or added i.e., modified some of the possible responses, the response verifier, which is based on the second API specification, will check if there is a delta/change between the expected and actual response at the two levels. Henceforth, within each response received there is a schema level check, and overall total number of possible responses returned by the proxy server [108] and the total number of expected responses is also verified.

Furthermore, a test result finalizer of the test engine [110] as depicted in FIG. 3, is connected to the test executor and is configured to generate final results at step 4101 and 4121, after the test executor notifies that all possible set of tests have been executed. More particularly, the test results from at least one of the backward testing flow represented and explained in reference to FIG. 4B and the forward testing flow represented and explained in reference to FIG. 4C, are combined and provided to the test result finalizer that generates the final test results. The test result finalizer stores those generated results in the test execution registry, initiates the building of the compatibility report, shuts down any running proxy servers etc. and frees up resources like ports, sockets, etc.

At step 414, a compatibility report generator [112] as depicted in FIG. 3, is configured to receive a notification from the test engine [110] that all possible set of tests have been completed and subsequently, it collates data from test registry and proxy registry. Further, it combines the data to identify compatible change/s, in-compatible change/s, structural change/s and unverified scenarios. For the compatible and incompatible changes, the compatibility report generator [112] also identifies and provides the nature of such change, i.e., forward compatible/incompatible, backward compatible/incompatible, etc.

Further, to illustrate the nature of changes identified by the compatibility report, which is based on data in test registry and proxy registry, consider an example where an operation in specification 1 expects response with a field name “status code,” which is an integer ranging between 1 and 4. Furthermore, consider the same operation in specification 2, which updates the same status code field in the response to an integer ranging between 1 and 3. So, while testing for backward compatibility, the configuration of the system is as follows: specification 1 acts as an input 1, which is leveraged by the Test Engine, and specification 2 acts as an input 2, which is leveraged by the proxy server [108], wherein the specification 1 and 2 could be different versions of the same API specification or different API specifications. Further, the proxy server [108] in this case generates possible responses, including boundary conditions where it considers a status code of 4. Accordingly, due to boundary condition failure on the response verification side, it registers the same with the proxy registry. Further, the test engine [110] in this case will consider the status code 4 to be within the boundary and correspondingly register the verification as a success in the test registry. Furthermore, the compatibility report generator [112] identifies this contradiction in the test and proxy registries, indicating that this is a backward compatible change. Additionally, in a forward compatible configuration, this contradiction will be reversed. The proxy registry considers response with status code field 4, which should be successfully processed. However, the test registry has the same record as a response verification failure because of a boundary condition failure. Thereby, this was reported as an incompatible change by the compatible report generator.

Additionally, the compatibility report records a reason for considering changes as compatible or not compatible and the time computation etc. In an example, say the first API specification is an OpenAPI 3.x standard which supports links which are able to convey which API endpoint and operation needs to be called before another one, describing workflow, however, this capability may not be available in the second API specification like API BluePrint or Swagger 2 and hence, the system cannot verify if there has been a change in the workflow itself, thus, this will be listed under the unverified scenarios.

Although the flows for backward compatibility and forward compatibility testing have been shown and explained in reference to FIGS. 4A, 4B and 4C, it will be appreciated by those skilled in the art that the present invention is not limited to this specific flow. Although the system proposed by the present invention is capable of testing forward, backward and full compatibility, it is clarified that the systems and methods described herein may be used to test forward, backward and full compatibility all at once, or one at a time or sequentially or parallelly or any combination thereof.

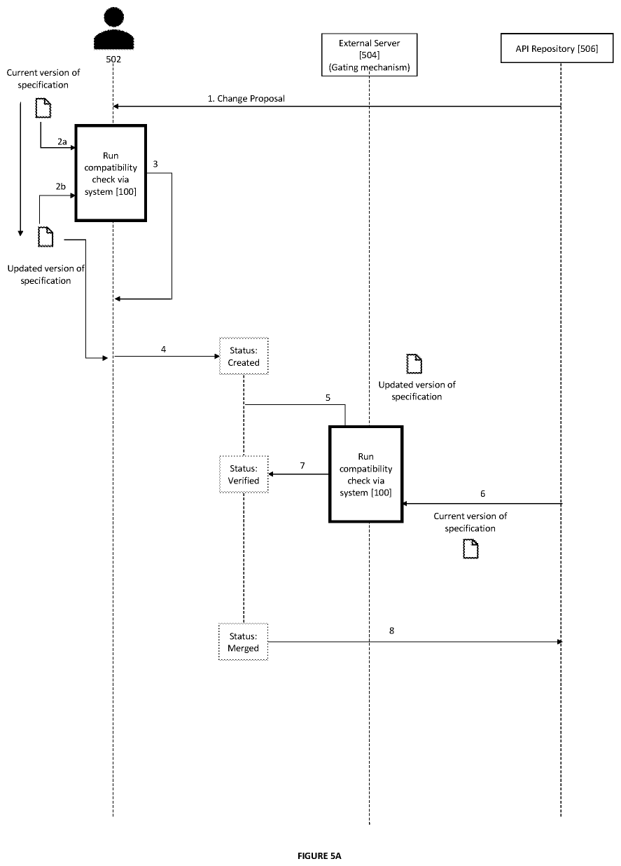

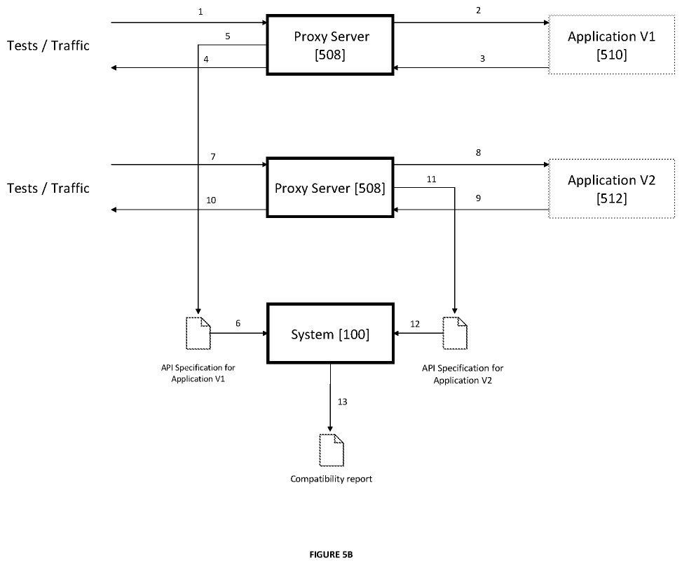

Referring to FIG. 5A, which illustrates exemplary situations in which exemplary embodiments of the systems and methods of the present invention are implemented.

In an example, the present invention may be implemented at a local device or user equipment where a user may wish to run a compatibility check between two API specifications that are already available or when the user may wish to update a current version of an API specification and check compatibility between the updated and the current version. In this example, at step 1, the API specifications (i.e., the first API specification or the current API specification in this example and optionally the second API specification or the updated API specification in this example) is retrieved from an API repository such as an API Management tool on a local machine as a part of a change proposal/request such as a pull-merge request, wherein the API Repository [506] could be a Version Control System such as Git, API Management Tool etc. At step 2a and 2b, API specifications say, a current version of API specification and an updated version of API specification are run for a compatibility check that is performed on the local machine at step 3, wherein the compatibility check could be a forward or backward by way of implication (of both backward and forward compatibility) a full compatibility check. Further, a status based on the test is created, wherein the status is in terms of pass or fail at step 4. Thus, in this implementation, the user at his/her local machine is able to test compatibility between two specifications.

In another example, the user may wish to persist or store an updated specification in the API repository. In this example, the updated version of the API specification is retrieved from the local machine and current version is retrieved from the API repository. Furthermore, a compatibility check is performed on the updated version of the API specification and the current version of the API specification at an external server [504] that acts as a gating mechanism. Thereafter, the status created is verified at step 7, i.e., it is checked whether the updated API specification is compatible with the current API specification. In case the updated API specification is compatible, the updated API specification is stored at the API repository. Thus, implementation of the present invention at the external server acts as a gating mechanism, whereby an updated API specification is stored in the repository only after it has been checked to be compatible with the current API specification.

Referring to FIG. 5B, which illustrates another exemplary situation in which exemplary embodiments of the systems and methods of the present invention are implemented. In an example, the present invention may check for compatibility testing at the pre-production stage or the production stage but the disclosure is not limited thereto. As shown in FIG. 5B, application v1 [510] and application v2 [512] are two versions of the same application during pre-production stage or the production stage. In this implementation, the system [100] is run as a recording reverse proxy server [508]. At steps 1-4 and 7-10 test or traffic data for different applications is run through the recording reverse proxy server [508]. At steps 5 and 11, the recording reverse proxy server [508] captures the traffic as API specifications of the version 1 and version 2. At step 6 and 12, a compatibility test is run, at the system [100], between the two API specifications captured by the recording reverse proxy server [508] and correspondingly, at step 13, compatibility test report is generated.

FIG. 6, illustrates an example compatibility test report generated in accordance with the exemplary embodiments of the present invention. As shown in FIG. 6, the compatibility report includes details of the first API specification and the second API specification for which compatibility check has been performed, including the name, version number, etc. The report also includes an overall compatibility status indicating success/failure. Further, the report may also include a ‘change list’ that details the changes/differences between the first API specification and the second API specification. For each change (such as op_1, op_2, etc.) in the change list, the report also includes details of number of successfully tested scenarios/tests and number of failed scenarios/tests. The report also shows the list of unverified scenarios, list of structural changes, list of compatible changes and list of incompatible changes. It will be appreciated by those skilled in the art that the report format shown in FIG. 6 is only exemplary and does not limit the scope of the present invention in any manner whatsoever. Any other format of the report is also encompassed within the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for testing a compatibility between a first API specification and a second API specification, the method comprising:
receiving, at a communication unit [102], the first API specification and the second API specification, wherein the first API specification and the second API specification are associated with a single service;
processing, by an adapter unit [104], the first API specification through an interface to generate a first translated API specification;
processing, by the adapter unit [104], the second API specification through the interface to generate a second translated API specification;
generating, by a processing unit [106], a first set of scenarios for the first API specification based on the first translated API specification;
generating, by the processing unit [106], a second set of scenarios for the second API specification based on the second translated API specification;
generating, by a test engine [110], a set of executable tests based on the first set of scenarios;
initiating a proxy server [108] based on the second set of scenarios;
initiating, by the test engine [110], one or more executable tests from the set of executable tests, wherein each executable test from the set of executable tests is associated with a scenario from the first set of scenarios;
identifying, by the proxy server [108], a corresponding target scenario for each test from the one or more initiated tests, based on the second set of scenarios;
generating, by the proxy server [108], one or more responses for each said corresponding target scenario;
verifying, by the test engine[110], the generated one or more responses for each said corresponding target scenario based on a scenario from the first set of scenarios, said scenario is associated with the initiated one or more tests;
generating, by the test engine [110], a set of verification results based on verification of the generated one or more responses for each said corresponding target scenario; and
generating, by a compatibility report generator [112], a compatibility report based on at least the set of verification results.

2. The method as claimed in claim 1 wherein the compatibility report comprises at least one of a list of compatible changes, a list of incompatible changes, a list of structural changes and a list of unverified scenarios.

3. The method as claimed in claim 1, wherein the first API specification and the second API specification is one of a different version of a same API specification standard and different API specification standards.

4. The method as claimed in claim 1 wherein the one or more the set of executable tests are generated dynamically based on the one or more scenarios generated for the first API specification.

5. The method as claimed in claim 1 wherein the first translated API specification and the second translated API specification is in a common standardized format.

6. The method as claimed in claim 1, wherein the method is implemented at least one of a specification authoring stage, a specification change review stage, a pre-production stage and a production stage.

7. The method as claimed in claim 1 wherein the compatibility between the first API specification and the second API specification is one of a forward compatibility, a backward compatibility and a full compatibility.

8. A system for testing a compatibility between a first API specification and a second API specification, the system comprising:
a communication unit [102] configured to receive the first API specification and the second API specification;
an adapter unit [104] connected to at least the communication unit [102], wherein the adapter unit [104] is configured to:
process the first API specification through an interface to generate a first translated API specification, and
process the second API specification through the interface to generate a second translated API specification;
a processing unit [106] connected to at least the adapter unit [104], wherein the processing unit [106] is configured to:
generate a first set scenarios for the first API specification based on the first translated API specification, and
generate a second set of scenarios for the second API specification based on the second translated API specification;
a test engine [110] connected to at least the processing unit [106], wherein the test engine [110] is configured to:
generate a set of executable tests based on the first set of scenarios; initiate one or more executable tests from the set of executable tests associated with a scenario from the first set of scenarios;
verifies the generated one or more responses for each said corresponding target scenarios based on a scenario from the first set of scenarios, said scenario is associated with the initiated one or more tests;
generate a set of verification results based on verification of the generated one or more responses for each said corresponding target scenario;
a proxy server [108] connected to at least the test engine [110], wherein the proxy server [108] is configured to:
generate a proxy implementation based on the second set of scenarios; identify a corresponding target scenario for each test from the one or more initiated tests based on the second set of scenarios;
generate one or more responses for each said corresponding target scenario; and
a compatibility report generator [112] connected at least the test engine [110] and the proxy server [108], wherein the compatibility report generator [112] is configured to generate a compatibility report based on at least the set of verification results.

9. The system as claimed in claim 8 wherein the compatibility report comprises at least one of a list of compatible changes, a list of incompatible changes, a list of structural changes and a list of unverified scenarios.

10. The system as claimed in claim 8 wherein the first API specification and the second API specification is one of a same API specification and a different API specification.

11. The system as claimed in claim 8 wherein set of the set of executable tests are generated dynamically based on the set of scenarios generated for the first API specification.

12. The system as claimed in claim 8 wherein the first translated API specification and the second translated API specification is in a pre-defined format.

13. The system as claimed in claim 8, wherein the system is implemented at least one of a specification authoring stage, a specification change review stage, a pre-production stage and a production stage.

14. A non-transitory computer-readable medium comprising computer-executable instructions that, when executed by a computing system, cause the computing system to perform a method for testing a compatibility between a first API specification and a second API specification, the method comprising:
receiving, at a communication unit [102], the first API specification and the second API specification, wherein the first API specification and the second API specification are associated with a single service;
processing, by an adapter unit [104], the first API specification through an interface to generate a first translated API specification;
processing, by the adapter unit [104], the second API specification through the interface to generate a second translated API specification;
generating, by a processing unit [106], a first set of scenarios for the first API specification based on the first translated API specification;
generating, by the processing unit [106], a second set of scenarios for the second API specification based on the second translated API specification;
generating, by a test engine [110], a set of executable tests based on the first set of scenarios;
initiating a proxy server [108] based on the second set of scenarios;
initiating, by the test engine [110], one or more executable tests from the set of executable tests, wherein each executable test from the set of executable tests is associated with a scenario from the first set of scenarios;
identifying, by the proxy server [108], a corresponding target scenario for each test from the one or more initiated tests, based on the second set of scenarios;
generating, by the proxy server [108], one or more responses for each said corresponding target scenario;
verifying, by the test engine[110], the generated one or more responses for each said corresponding target scenario based on a scenario from the first set of scenarios, said scenario is associated with the initiated one or more tests;
generating, by the test engine [110], a set of verification results based on verification of the generated one or more responses for each said corresponding target scenario; and
generating, by a compatibility report generator [112], a compatibility report based on at least the set of verification results.
